(19) United States
(12) Patent Application Publication
(10) Pub. No.: US 2010/0199191 A1
(43) Pub. Date: Aug. 5, 2010

(54) COLLABORATIVE WORK APPARATUS AND METHOD OF CONTROLLING COLLABORATIVE WORK

(75) Inventor: Yusuke Takahashi, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/698,769

(22) Filed: Feb. 2, 2010

(30) Foreign Application Priority Data
Feb. 3, 2009 (JP) 2009-023051

(51) Int. Cl. G06F 3/048

(52) U.S. Cl. 715/741; 715/751; 715/856

(57) ABSTRACT

A collaborative work apparatus includes: a display unit that simultaneously displays work contents edited or referenced by a plurality of users and cursors of a plurality of the users on a display screen; a cursor manipulation input unit that inputs a manipulation signal for each cursor; a cursor manipulation control unit that sets one or more manipulation areas on the display screen and executes control of cursor locations of each of the users on the display screen and control of granting/removing manipulation authority over each manipulation area to/from any one of the users in response to the cursor manipulation signal input from the user through the cursor manipulation input unit; and manipulation authority management unit that manages manipulation authority information representing which user has the manipulation authority over which manipulation area in response to the control of granting/removing the manipulation authority by the cursor manipulation control unit.

### BACKGROUND

1. Technical Field

The present invention relates to a collaborative work apparatus and a method of controlling collaborative work for allowing participants to edit the same file or document during a conference or a collaborative work where a plurality of users participate.

2. Related Art

Typically, examples of materials used in a conference include brochures, documents projected on a screen using an image projector, descriptions on a white board, or the like. During the conference, all the participants share important issues in such a way that any participant describes an important item using a white board, or a user of a personal computer connected to the image projector representatively writes important items on the projected electronic file. Descriptions on the white board are often printed using a printer accompanying the white board and distributed to the participants after the conference.

In order to effectively perform such a conference process, for example, JP-A-11-65975 and JP-A-2007-213511 discloses a method in which a conference is carried on by connecting a shared screen device and terminal devices of each participant to one another via a network, manipulating the shared screen using each terminal device, and executing mouse manipulation or character input, and after the conference, a conference record is completed as electronic data, or desired data is compiled.

When such a collaborative work is executed, it is necessary to allow a plurality of users to individually write, delete, modify, or edit a shared file or document displayed on a single screen or window. In this case, it is necessary to avoid conflicts of cursor manipulation or editing between different users. A method of addressing this problem is disclosed in Japanese Patent No. 3,501,556.

In the control method disclosed in Japanese Patent No. 3,501,556, a manipulation pointer for manipulating an application on a certain application window is displayed, and each host user clicks a mouse cursor on that manipulation pointer so that the host having manipulation authority over that application is changed.

The control method disclosed in Japanese Patent No. 3,501,556 has some problems as follows. First, a single manipulation authority is present for a single application, and only a single host (or a single user) is allowed to have manipulation authority at a given time. For this reason, a plurality of users cannot simultaneously manipulate contents displayed on the application window, and thus, an advantage of the collaborative work performed by a plurality of users cannot be promoted. Second, a cursor of the host without manipulation authority as well as a cursor of the host with manipulation authority can be disposed on the same application window. Therefore, the cursor of the host without manipulation authority may hinder work by the host with manipulation authority in editing or referencing the contents on that window.

### SUMMARY

An advantage of an aspect of the invention is to provide a method of controlling the manipulation authority such that an advantage of the collaborative work performed by a plurality of users can be promoted by increasing manipulation freedom of each user in a conference or a collaborative work.

An advantage of another aspect of the invention is to control a cursor such that a cursor of the user without manipulation authority does not hinder works of a user with manipulation authority.

According to an aspect of the invention, there is provided a collaborative work apparatus including: a display unit that simultaneously displays work contents edited or referenced by a plurality of users and cursors of a plurality of the users on a display screen; a cursor manipulation input unit that inputs a cursor manipulation signal for each cursor; a cursor manipulation control unit that sets one or more manipulation areas on the display screen and executes control of cursor locations of each of the users on the display screen and control of granting/removing manipulation authority for each manipulation area to/from any one of the users in response to the cursor manipulation signal input from the user through the cursor manipulation input unit; and manipulation authority management unit that manages manipulation authority information representing which user has the manipulation authority over which manipulation area in response to the control of granting/removing the manipulation authority by the cursor manipulation control unit. The cursor manipulation control unit of the collaborative work apparatus includes: a manipulation area detection unit that detects which manipulation area is requested by each of the users on the display screen based on the cursor manipulation signal from each of the users; a manipulation authority determination unit that determines which user has the manipulation authority over the requested manipulation area detected by the manipulation area detection unit based on the manipulation authority information; a manipulation authority grant unit that determines whether or not the manipulation authority over the requested manipulation area is granted to the requesting user according to a result of determination by the manipulation authority determination unit; and manipulation authority deprivation unit that determines whether or not each of the users satisfies a predetermined manipulation authority disqualifying condition and whether or not the manipulation authority held by each of the users is deprived based on the cursor manipulation signal from each user.

According to this construction, each user can request for a desired area on the display area as a manipulation area through cursor manipulation, and whether or not the manipulation authority over the requested manipulation area can be obtained according to whether or not the manipulation authority over the requested manipulation area is held by another user. For example, if the manipulation authority over the requested manipulation area is held by none of users, that user can obtain the manipulation authority over the requested manipulation area. An area that can be requested as a manipulation area may be any area on the display screen. Typically, the area that can be requested as the manipulation area may include work contents areas displayed on the display screen (e.g., icons, application windows, or files displayed on the window) or a part of work contents areas (e.g., a part of an area within the window or a part of an area of a file displayed within a window (such as a paragraph, a sentence, a character, a cell, a figure, a section, a footer, a header, a frame, and a part of files opened in a window)). Each of different users can obtain manipulation authority over each of different manipulation areas (e.g., different areas within a single window). Each manipulation area may be previously fixed (e.g., when a document file is displayed on the window, each paragraph within the document file may be automatically set as a manipulation area) or dynamically set as necessary (e.g., when a user designates an arbitrary area within the file on the display screen, the designated area may be set as a manipulation area).

It is preferable that the cursor manipulation control unit further includes a cursor access control unit that controls whether or not the cursor of each of the users is permitted to access each manipulation area based on the manipulation authority information.

According to this construction, whether or not a cursor of a certain user can access a certain manipulation area is controlled based on the manipulation authority information, i.e., which user has manipulation authority over each manipulation area. For example, if the manipulation authority over a certain manipulation area is held by none of users, then the cursor of the user is allowed to access that manipulation area. Otherwise, if manipulation authority is held by another user, then the cursor of the user is not allowed to access that manipulation area. As a result, since the cursor of a user who does not have the manipulation authority over that manipulation area cannot access that manipulation area, work by the user with that manipulation authority is not hindered.

It is preferable that the manipulation authority grant unit grants the manipulation authority over the requested manipulation area to the requesting user when none of the users have manipulation authority over the requested manipulation area but does not grants the manipulation authority over the requested manipulation area to the requesting user when another user has the manipulation authority over the requested manipulation area.

It is preferable that, when a cursor of a certain user tries to access a certain manipulation area, if the manipulation authority over the corresponding manipulation area is not held by another user, the cursor manipulation control unit permits the cursor of the corresponding user to access the corresponding manipulation area, whereas if the manipulation authority over the corresponding manipulation area is held by another user, the cursor manipulation control unit inhibits the cursor of the corresponding user to access the corresponding manipulation area.

It is preferable that, when a cursor of a certain user tries to access a certain manipulation area, the manipulation area detection unit detects the corresponding manipulation area as a requested manipulation area of the corresponding user.

It is preferable that, when a cursor of a certain user designates a certain manipulation area, the manipulation area detection unit detects the corresponding area as a requested manipulation area of the corresponding user.

It is preferable that, when a cursor of a certain user starts editing in a certain place on the work contents, the manipulation area detection unit detects the manipulation area including the corresponding place as an requested manipulation area of the corresponding user.

It is preferable that, when cursor manipulation of a user with manipulation authority over a certain manipulation area has not been executed for a predetermined time, the manipulation authority deprivation unit deprives the manipulation authority over the corresponding manipulation area held by the corresponding user.

It is preferable that, when a cursor of a user with manipulation authority of a certain manipulation area moves out of the corresponding manipulation area, the manipulation area deprivation unit deprives the manipulation authority over the corresponding manipulation area held by the corresponding user.

It is preferable that, when a cursor of a user with manipulation authority over a first manipulation area newly obtains manipulation authority over a second manipulation area, the manipulation authority deprivation unit deprives manipulation authority over the first manipulation area held by the corresponding user.

It is preferable that the collaborative work apparatus further includes a cursor display control unit that controls the display state of each cursor to visually distinguish a cursor of a user who has or obtains manipulation authority over any manipulation area from a cursor of a user who does not.

It is preferable that the collaborative work apparatus further includes an area display control unit that controls a display state of each manipulation area to visually distinguish a manipulation area of which manipulation authority is held by any user from a manipulation area of which manipulation authority is held by none of users.

It is preferable that the collaborative work apparatus is communicatably connected to one or more other terminal devices via a communication network, and the cursor manipulation input unit inputs a cursor manipulation signal input to collaborative work apparatus from a host user and a cursor manipulation signal input to one or more other terminal devices from one or more other users.

According to this construction, at least one of the terminal devices connected via a communication network may function as a collaborative work apparatus according to an embodiment of the invention. Otherwise, each of the terminal devices may function as a collaborative work apparatus according to an embodiment of the invention.

According to another aspect of the invention, there is provided a method of controlling a collaborative work, the method comprising: a display step for simultaneously displaying work contents edited or referenced by a plurality of users and cursors of a plurality of the users on a display screen; a cursor manipulation input step for inputting a cursor manipulation signal for each cursor; a manipulation area setting step for setting one or more manipulation areas on the display screen; a cursor manipulation control step for executing control of a cursor location of each of the users on the display screen and control of granting/removing manipulation authority over each manipulation area for each of the users in response to the cursor manipulation signal of each of the users, input through the cursor manipulation input step; and a manipulation authority management step for managing manipulation authority information representing which user has manipulation authority over which manipulation area in response to the control of granting/removing the manipulation authority obtained through the cursor manipulation control step. In this method, the cursor manipulation control step includes: a manipulation area detection step for detecting which manipulation area is requested by each of the users on the display screen based on the cursor manipulation signal of each of the users; a manipulation authority determination step for determining which user has the manipulation authority over the requested manipulation area of each of the users, detected through the manipulation area detection step based on the manipulation authority information; a manipulation authority grant step for determining whether or not the manipulation authority over the requested manipulation area is granted to each of the users according to a result of the determination obtained through the manipulation authority determination step; and a manipulation authority deprivation step for determining whether or not each of the users satisfies a predetermined manipulation authority disqualifying condition and whether or not the manipulation authority held by each of the users is deprived based on the cursor manipulation signal of each user.

According to still another aspect of the invention, there is provided a computer program for executing the aforementioned control method on a computer.

In the collaborative work apparatus according to an embodiment of the invention, one or more manipulation area can be set on the display screen, and the manipulation authority over each manipulation area can be granted to any one of users. For example, when any user has not yet obtained manipulation authority over a desired manipulation area, each user puts his/her cursor into that manipulation area and designates that manipulation area by clicking a mouse or using a method of designating a range. Alternatively, the manipulation authority over that manipulation area can be obtained by starting editing within that manipulation area. As a result, manipulation authority over different display areas on the display screen can be granted to different users. Also, a plurality of users can simultaneously execute editing on the same display screen.

According to an exemplary embodiment of the invention, after a certain user obtains manipulation authority over a certain manipulation area, if the user does not execute cursor manipulation for a predetermined time, moves the cursor out of that manipulation area, or newly obtains manipulation authority over another manipulation area, that user loses the manipulation authority over the former manipulation area, and another user can obtain the manipulation authority over that manipulation area. As a result, since manipulation authority over a certain manipulation area is not unnecessarily occupied by a single user for a long time, it is possible to more harmoniously carry on collaborative work by a plurality of users.

According to an exemplary embodiment of the invention, if a certain user has manipulation authority over a certain manipulation area, cursors of other users are not allowed to access that manipulation area. As a result, since editing of each user is not hindered by cursors of other users, it is possible to harmoniously carry on the collaborative work by a plurality of users.

### BRIEF DESCRIPTION OF THE DRAWINGS

The invention will be described with reference to the accompanying drawings, wherein like numbers reference like elements.

FIG. 1 illustrates an exemplary construction of a collaborative work system including a collaborative work apparatus according to an embodiment of the invention.

FIG. 2 is a functional block diagram illustrating a collaborative work apparatus according to an embodiment of the invention in the collaborative work system shown in FIG. 1.

FIG. 3 is a sequence diagram illustrating a basic control flow of the collaborative work system shown in FIG. 1.

FIG. 4 illustrates a manipulation authority information table recorded in a manipulation management unit 15 of a large scale display device 3 (i.e., the collaborative work apparatus) shown in FIG. 2.

FIG. 5 illustrates an exemplary method of defining a manipulation area within a coordinates range on a display screen.

FIG. 6 is a flowchart illustrating a control flow for grating/depriving manipulation authority, executed by a cursor manipulation control unit 13 of a large scale display device 3.

FIG. 7 is a manipulation authority information table when the manipulation authority is not granted to any of the manipulation areas as an initial state.

FIG. 8 illustrates a display screen when a user “S. J” obtains the manipulation authority over the entire window of a manipulation area ID “Sample.doc”.

FIG. 9 illustrates a manipulation authority information table when a user “S. J” obtains the manipulation authority of FIG. 8.

FIG. 10 illustrates a display screen when a user “S. J” manipulates a cursor to get out of a certain manipulation area and loses manipulation authority.

FIG. 11 illustrates a display screen when each of users “S. J” and “Ichi” obtains manipulation authority over a different manipulation area in a window.

FIG. 12 illustrates a manipulation authority information table when each of users “S. J” and “Ichi” obtains manipulation authority in FIG. 11.

FIG. 13 illustrates a display screen when each of users “S. J” and “Tar” obtains manipulation authority over a different manipulation area in a single window.

FIG. 14 illustrates a manipulation authority information table when each of users “S. J” and “Tar” obtains manipulation authority in FIG. 13.

FIG. 15 illustrates a display screen when manipulation authority over a certain manipulation area is granted to a single user, and another user is prohibited to obtain manipulation authority over the manipulation area conflicting with that manipulation area.

FIG. 16 illustrates a display screen when a cursor of the user “S. J” accesses a certain window.

FIG. 17 illustrates a display screen when the user “S. J” is granted to have the manipulation authority over the manipulation area appointed through appointment manipulation of a user “S. J” in succession to FIG. 16.

FIG. 18 illustrates a manipulation authority information table when the user “S. J” obtains that manipulation authority in FIG. 17.

FIG. 19 illustrates a display screen when the user “S. J” has manipulation authority over a certain manipulation area.

FIG. 20 illustrates a display screen when the user “S. J” newly obtains manipulation authority over another manipulation area in succession to FIG. 19.

FIG. 21 illustrates a display screen when the user “S. J” loses manipulation authority over the former manipulation area, and another user “Ichi” obtains manipulation authority over that manipulation area in succession to FIG. 20.

FIG. 22 is a flowchart illustrating a control flow when a certain user obtains manipulation authority over a new manipulation area and is deprived of manipulation authority over the former manipulation area, and that manipulation authority can be obtained by other users as shown in FIGS. 19 to 21.

FIG. 23 illustrates a manipulation authority information table when the user “S. J” has the manipulation authority in FIG. 19.

FIG. 24 illustrates a manipulation authority information table when the user “S. J” newly obtains manipulation authority over another manipulation area and loses manipulation authority over the former manipulation area in FIGS. 20 and 21.

### DESCRIPTION OF EXEMPLARY EMBODIMENTS

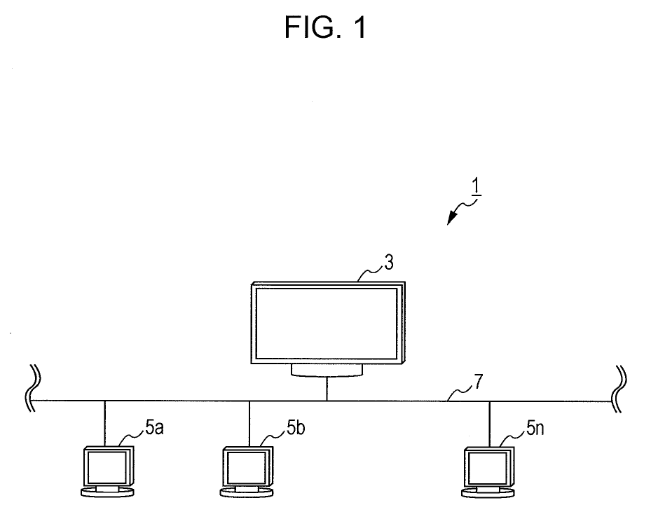

Hereinafter, a collaborative work apparatus according to an embodiment of the invention will be described in detail with reference to the accompanying drawings. FIG. 1 illustrates an exemplary construction of a collaborative work system employing the collaborative work apparatus according to an embodiment of the invention.

A collaborative work system 1 is provided to allow a plurality of users to reference or cooperatively edit the same work contents (e.g., electronic data such as presentation materials and conference records) during a conference or a collaborative work. For example, a single cooperatively-used large scale display device 3 and a plurality of personally-used terminal devices 5a, 5b, and 5n are communicatably connected to one another via a communication network 7.

The large scale display device 3 has a display device capable of displaying a large scale screen such as a flat panel display, an electronic white board, and a liquid crystal image projector. For example, the large scale display device 3 is installed in a conference room in order to allow users gathered in the conference room to see the information displayed on the large scale screen together.

Each terminal device 5a, 5b, and 5n is a portable or stationary computer (e.g., a mobile phone or a portable personal computer brought by each user, a personal computer used by each user in an office, or the like) used by each user personally. Each terminal device 5a, 5b, and 5n functions as a collaborative work apparatus according to an embodiment of the invention by executing a program installed therein.

The large scale display device 3 is a sort of computer that can also be used as a kind of the personal terminal device like each terminal device 5a, 5b, or 5n, and functions as a collaborative work apparatus according to an embodiment of the invention. It can be considered that the system shown in FIG. 1 is obtained by communicatably connecting a plurality of collaborative work apparatuses 3, 5a, 5b, and 5n according to an embodiment of the invention via a network.

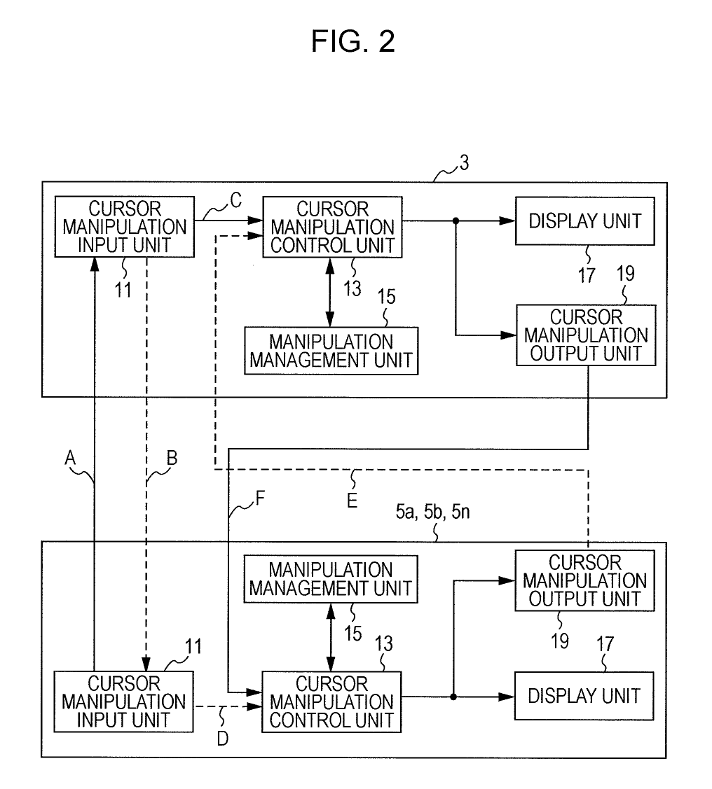

FIG. 2 is a functional block diagram illustrating a collaborative work apparatus according to an embodiment of the invention in a collaborative work system shown in FIG. 1.

Both the large scale display device 3 and each of the terminal devices 5a, 5b, and 5n function as a collaborative work apparatus according to an embodiment of the invention, and their functional constructions as a collaborative work apparatus are basically similar. While FIG. 2 illustrates a functional construction of the large scale display device 3 as a collaborative work apparatus and a functional construction of each of the terminal devices 5a, 5b, and 5n as a collaborative work apparatus, functional constructions of the large scale display device 3 as a collaborative work apparatus will be representatively described below.

The large scale display device 3 includes a cursor manipulation input unit 11, a cursor manipulation control unit 13, a manipulation authority management unit 15, a display unit 17, and a cursor manipulation output unit 19.

The cursor manipulation input unit 11 has a function of receiving a cursor manipulation signal input to an own terminal device (herein, the large scale display device 3) from a user of the own terminal device, for example, by manipulating a mouse (not shown). The cursor manipulation input unit 11 also has a function of receiving from the cursor manipulation input units 11 of the other terminal devices a cursor manipulation signal input to each of other terminal devices (herein, the terminal device 5a, 5b, and 5n) from users of the other terminal devices (as illustrated as an arrow A in the drawing). In addition, the cursor manipulation input unit 11 has a function of transmitting to other terminal devices the cursor manipulation signal input from a user of the own terminal device to the own terminal device (as illustrated as an arrow B in the drawing). However, the function illustrated as the arrow B is not used in the present embodiment (not necessarily). Therefore, the cursor manipulation input unit 11 of the large scale display device 3 can receive the cursor manipulation signals of both the large scale display device 3 and the terminal devices 5a, 5b, and 5n, whereas the cursor manipulation input units 11 of the terminal devices 5a, 5b, and 5n are not configured in the same manner. The present embodiment of the invention is constructed in such a manner in order to allow the large scale display device 3 to execute control subjectively based on the cursor manipulation signal according to an embodiment of the invention and the terminal devices 5a, 5b, and 5n to be operated subordinately depending on the control result of the large scale display device 3.

The cursor manipulation control unit 13 has functions of controlling the location of the cursor of each user, being displayed on a display screen, using the display unit 17, setting one or more manipulation areas within the entire display area on the display screen and controlling which manipulation authority over the manipulation area is allocated to which user (or cursor) based on the cursor manipulation signals input to the cursor manipulation input unit 11 from the own and other terminal devices (as illustrated as an arrow C in the drawing). That is, the cursor manipulation control unit 13 has functions of setting the manipulation area on the display screen based on the cursor manipulation signal of each user and granting/removing manipulation authority over a certain manipulation area to/from a certain user. The cursor manipulation input units 11 of other terminal devices 5a, 5b, and 5n have a similar function (as illustrated as an arrow D in the drawing). However, the function shown as the arrow D is not used in the present embodiment (not necessarily). Therefore, only the cursor manipulation control unit 13 of the large scale display device 3 can have the corresponding function. The present embodiment of the invention is constructed in such a manner in order to allow the large scale display device 3 to execute control subjectively based on the cursor manipulation signal according to an embodiment of the invention and the terminal devices 5a, 5b, and 5n to be operated subordinately depending on the control result of the large scale display device 3.

The cursor manipulation control unit 13 also has functions of stopping subjectively controlling the cursor location and granting/removing the manipulation authority as described above, and instead, receiving a result of controlling the cursor location and a result of controlling granting/removing the manipulation authority executed by a cursor manipulation control unit 13 of any other terminal devices (as illustrated as an arrow E in the drawing). The cursor manipulation control units 13 of other terminal devices 5a, 5b, and 5n also have a similar function (as illustrated as an arrow F in the drawing). However, the function illustrated as an arrow E is not used in the present embodiment (not necessarily). Therefore, only the cursor manipulation control units 13 of other terminal devices 5a, 5b, and 5n can have the corresponding function (as illustrated as an arrow F in the drawing). The present embodiment of the invention is constructed in such a manner in order to allow the large scale display device 3 to execute control subjectively based on the cursor manipulation signal according to an embodiment of the invention and the terminal devices 5a, 5b, and 5n to be operated subordinately depending on the control result of the large scale display device 3.

Herein, the “manipulation area” may be any area that can be set on the display screen by executing predetermined cursor manipulation. A typical example of areas that can be set as the “manipulation area” will be described. For example, the manipulation area may include each work content on the display screen (e.g., icons, application windows, or files displayed on the window). In addition, the manipulation area may include a part of each work contents area, for example, a part of an area within the window or a part of an area of a file displayed within a window (such as a paragraph, a sentence, a character, a cell, an image, a figure, a table, a section, a footer, a header, a frame, a part of files opened in a window).

The manipulation authority management unit 15 has a function of storing and managing manipulation authority information (i.e., information regarding which user has manipulation authority over which manipulation area) representing the status of the manipulation authority controlled or received by the cursor manipulation control unit 13. According to the present embodiment of the invention (not necessarily), the cursor manipulation control unit 13 of the large scale display device 3 subjectively controls the manipulation authority, and the manipulation authority information representing the result thereof is stored in the manipulation authority management unit 15 of the large scale display device 3. Also, such manipulation authority information is transmitted to each of other terminal devices 5a, 5b, and 5n by the function of the aforementioned arrow F and stored in the manipulation authority management unit 15 of each terminal device 5a, 5b, and 5n. As a result, both the large scale display device 3 and all the terminal devices 5a, 5b, and 5n share the same manipulation authority information.

The display unit 17 has a display screen to display work contents (such as icons and windows), cursors of a plurality of users, of which each location is controlled by the cursor manipulation control unit 13, and manipulation areas of which each manipulation authority is controlled by the cursor manipulation control unit 13 thereon.

The cursor manipulation output unit 19 has a function of notifying other terminal devices 5a, 5b, and 5n of a result of controlling cursor locations using the cursor manipulation control unit 13 and a result of controlling the manipulation authority (as illustrated as an arrow F in the drawing). While cursor manipulation output units 19 of other terminal devices 5a, 5b, and 5n have a similar function (as illustrated as an arrow E in the drawing), this function is not used in the present embodiment.

Since other terminal devices 5a, 5b, and 5n have a similar functional construction to that of the large scale display device 3 as described above, a description thereof will be omitted. However, in the present embodiment, since the functions B, D, and E illustrated as a dashed line in FIG. 2 are not used, the large scale display device 3 executes subjective control as a master, and other terminal devices 5a, 5b, and 5n subordinately follow the result of control of the large scale display device 3 as slaves. However, this is an example for description, but the control may be executed in a different way. As a modified example, any one (e.g., the terminal device 5a) of the personal terminal devices 5a, 5b, and 5n may function as a master, and other terminal devices 5b and 5n and the large scale display device 3 may function as slaves. Alternatively, as another modified example, each of the large scale display device 3 and other terminal devices 5a, 5b, and 5n may communicate with one another through the cursor control signal, receive the cursor manipulation signals of all users, and independently control the cursor location and the manipulation authority.

The functions of the cursor manipulation control unit 13 of the large scale display device 3 according to the present embodiment will now be described in detail. While the cursor manipulation control units 13 of other terminal devices 5a, 5b, and 5n have a similar function, this function is not used because other terminal devices 5a, 5b, and 5n function as slaves in the present embodiment (of course, this function may be used in a modified example).

The cursor manipulation control unit 13 has the following functions.

(1) Setting one or more manipulation areas on the display screen (corresponding to a manipulation area setting unit), in which setting the manipulation area may be previously executed based on a structure of a display image on the display screen (e.g., which work content is located where on the display screen) irrespective of the cursor manipulation signal from a user (manipulation area pre-setting). For example, when a window is displayed on the display screen, that window may be set as a manipulation area. Alternatively, when a certain file is opened on that window, each of the file itself and components of that file (such as a paragraph, a sentence, a character, an image, a figure, a table, and a picture image) may be set as a manipulation area. Alternatively, as will be described in the function (2) below, when it is detected, based on a cursor manipulation signal from a certain user, that a certain area on the display screen is requested by that user, the requested area may be set as a manipulation area (manipulation area dynamic setting or real-time setting).

(2) Detecting which manipulation area on the display screen is requested by each user based on the cursor manipulation signal from each user (corresponding to a manipulation area detection unit). In a case where the manipulation area real-time setting is executed according to the function (1), when the manipulation area detection unit detects which area on the display screen is requested by each user, the detected area is set as a manipulation area. As one of methods of detecting the requested manipulation area, when a cursor of a certain user tries to access a certain manipulation area, that manipulation area may be detected as the manipulation area requested by the user. Alternatively, as another detection method, when the cursor of a certain user designates a certain manipulation area (e.g., in a method of designating ranges, by enclosing that manipulation area, overlapping a designated range to that manipulation area, or allowing the cursor to access that manipulation area and clicking a mouse, or the like), that manipulation area may be detected as the manipulation area requested by the user. Alternatively, as still another detection method, when a certain user puts a cursor onto a certain location of certain work content and starts editing at that place, the manipulation area including that place may be detected as the manipulation area requested by the user (e.g., when the user starts editing at a certain location of a certain character of a certain paragraph of a certain file, that paragraph may be detected as the manipulation area). Theses methods may be employed selectively or in combination.

(3) Determining which user has the manipulation authority over the requested manipulation area of each user, detected by the manipulation area detection unit in the aforementioned function (2) based on manipulation authority information stored in the manipulation authority management unit 15 (refer to FIG. 2) (corresponding to a manipulation authority determination unit).

(4) Determining whether or not the manipulation authority over the requested manipulation area is to be granted to each user based on the result of the determination of the manipulation authority determination unit of the aforementioned function (3) (corresponding to a manipulation authority grant unit). As a method of determining whether or not the manipulation authority is to be granted, for example, when none of users has manipulation authority over a manipulation area requested by a certain user, the manipulation authority over the requested manipulation area is granted to that user. However, when another user has the manipulation authority over the requested manipulation area, the manipulation authority over the requested manipulation area may not be granted to that user.

(5) Determining whether or not each user satisfies a predetermined manipulation authority disqualifying condition based on the cursor manipulation signal from each user and determining whether or not the manipulation authority held by each user is to be deprived (corresponding to manipulation authority deprivation unit). As a method of determining whether or not the manipulation authority is to be deprived, for example, when cursor manipulation of a certain user has not been continuously performed for a predetermined time, that user may be deprived of manipulation authority. Alternatively, as another determination method, when a cursor of a certain user moves out of the manipulation area of the manipulation authority held by that user, that user may be deprived of the manipulation authority over that manipulation area. Alternatively, as still another determination method, when a user with manipulation authority over a certain manipulation area obtains manipulation authority over another manipulation area, that user may be deprived of the manipulation authority over the former authority area. Theses methods may be employed selectively or in combination.

(6) When a cursor of a certain user tries to access a certain manipulation area, controlling whether or not the cursor is to be permitted to access that manipulation area based on manipulation authority information stored in the manipulation authority management unit 15 (refer to FIG. 2) (corresponding to a cursor access control unit). For example, when the manipulation authority over that manipulation area is not held by any other users, the cursor is permitted to access that manipulation area. However, when the manipulation authority over that manipulation area is held by another user, the cursor may be inhibited to access that manipulation area.

(7) Controlling a display state of each cursor in order to visually distinguish a cursor of a user who has or obtains the manipulation authority over a certain manipulation area from a cursor of a user who does not (corresponding to a cursor display control unit). For example, different colors may be displayed between a cursor of a user having manipulation authority and a cursor of another user having no manipulation authority.

(8) Controlling the display state of manipulation areas in order to visually distinguish a manipulation area of which the manipulation authority is held by any one of users from a manipulation area of which the manipulation authority is held by none of users (corresponding to an area display control unit). For example, a fact that manipulation authority over a manipulation area is held by someone can be notified to all users by enclosing the manipulation area, of which the manipulation authority is held by any one of users, with a frame line having a particular color.

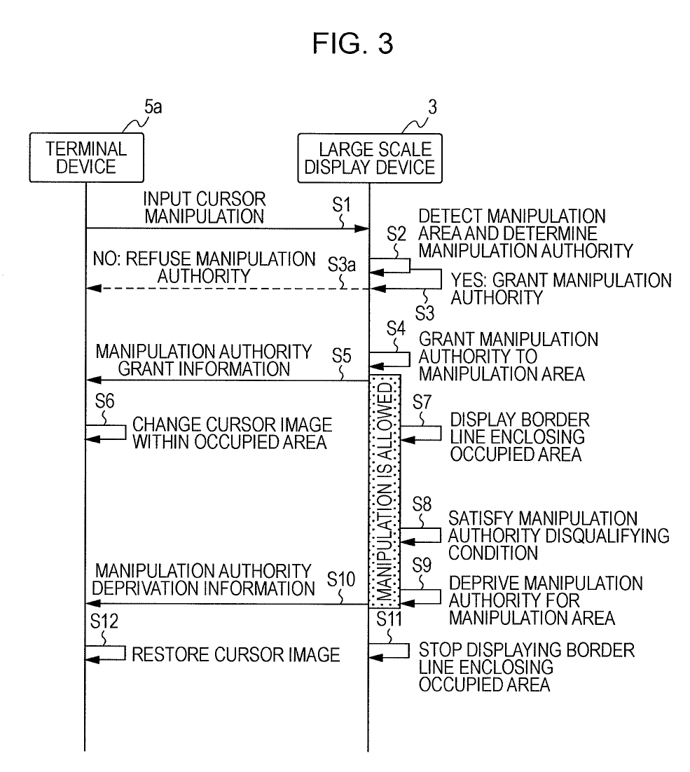

Subsequently, operations of the collaborative work system according to an embodiment of the invention constructed as shown in FIGS. 1 and 2 will be described. FIG. 3 is a sequence diagram illustrating a basic control flow of the collaborative work system according to an embodiment of the invention. In FIG. 3, while one terminal device 5a of the personal terminal devices 5a, 5b, and 5n is representatively shown, the operation can be similarly applied to other terminal devices 5b and 5n. While, in this case, the large scale display device 3 functions as a master, and the personal terminal devices 5a, 5b, and 5n function as slaves to execute the collaborative work, this is just exemplary, and a range of the present invention is not limited thereto.

Referring to FIG. 3, the cursor manipulation signal output from the cursor manipulation input unit 11 of the terminal device 5a (i.e., the cursor manipulation signal from a user of the terminal device 5a) is transmitted to the cursor manipulation input unit 11 of the large scale display device 3 (in step S1). The cursor manipulation control unit 13 of the large scale display device 3 controls a location of the corresponding cursor on the display screen based on the received cursor manipulation signal (the cursor manipulation signal from a user of the terminal device 5a) and detects whether or not the user is requesting a certain manipulation area on the display screen. If the requested manipulation area is detected, then it is determined whether or not the manipulation authority over the requested manipulation area can be granted to the corresponding user based on the manipulation authority information (in step S2).

If the cursor manipulation control unit 13 of the large scale display device 3 determines that the manipulation authority over the requested manipulation area can be granted to that user (in step S3), then the manipulation authority over that manipulation area is granted to that user (in step S4), and manipulation authority grant information (i.e., information representing which manipulation authority over the manipulation area is granted to which user) is transmitted from the cursor manipulation output unit 19 to the terminal device 5a (in step S5). Simultaneously, manipulation authority information within the large scale display device 3 is updated. As a result, the user of the terminal device 5a occupies the requested manipulation area. The terminal device 5a which received the manipulation authority grant information from the large scale display device 3 updates the manipulation authority information within the terminal device 5a based on the manipulation authority grant information. Also, the terminal device 5a executes change of the cursor image of that user (e.g., change of the cursor color) within the manipulation area occupied by that user (in step S6) (the same operation is also executed in the large scale display device 3).

If the granting of manipulation authority to that user is rejected in step S3, manipulation authority rejection information is sent from the large scale display device 3 to the terminal device 5a (in step S3a). When the manipulation authority is rejected, each of the large scale display device 3 and the terminal device 5a, for example, inhibits the cursor of that user from accessing that manipulation area or displays a dialog notifying that “impossible to manipulate” for that manipulation area.

Meanwhile, if the large scale display device 3 grants the manipulation authority to the user of the terminal device 5a in step S4, the large scale display device 3 notify a fact that the manipulation area is occupied by enclosing the manipulation area occupied by that user (i.e., of which the manipulation authority is granted to that user) with a predetermined frame line (in step S7) (the same operation is also executed in the terminal device 5a).

Then, if it is determined that a predetermined manipulation authority disqualifying condition is satisfied for that cursor (i.e., user) based on the cursor manipulation signal from the terminal device 5a (in step S8), then the manipulation authority control unit 13 of the large scale display device 3 deprives the manipulation authority over the corresponding manipulation area from that user (in step S9). The manipulation authority disqualifying condition may include a case where there is no cursor manipulation for a constant time, a case where the cursor moves out of the corresponding manipulation area, and/or a case where that user obtains manipulation authority over another manipulation area.

The large scale display device 3 transmits manipulation authority deprivation information (i.e., information representing which user is deprived of the manipulation authority over which manipulation area) from the cursor manipulation output unit 19 to the terminal device 5a (in step S10). Also, the manipulation authority information within the large scale display device 3 is updated. The large scale display device 3 stops displaying enclosing the occupied manipulation area with a frame line on the display screen (in step S11) and restores the cursor image to its original state. Similarly, the terminal device 5a stops displaying enclosing the occupied manipulation area with a frame line on the display screen by updating the manipulation authority information within the terminal device 5a in response to the manipulation authority deprivation information and restores the cursor image to its original state (in step S12).

In this manner, each user can obtain or lose the manipulation authority over a desired manipulation area on the display screen by manipulating own cursor. Since different manipulation areas can be set to different components on the same work content, a plurality of users may separately obtain the manipulation authority of different components on the same work contents and edit the same work contents collaboratively.

In the aforementioned process, a collaborative work is executed by setting the large scale display device 3 as a master and the terminal device 5a as a slave. However, as a modified example, the collaborative work may be executed by setting a terminal device (e.g., the terminal device 5a) other than the large scale display device 3 as a master. If the terminal device 5a becomes a master, the large scale display device 3 and the terminal device 5a may be exchanged in the aforementioned description. As another modified example, each of the large scale display device 3 and the terminal devices 5a, 5b, and 5n may control granting/removing the manipulation authority (e.g., each device controls granting/removing the manipulation authority to/from users of itself) and mutually exchange the results of the control so that the manipulation authority information as the results of the control may be unified among all the large scale display device 3 and the terminal devices 5a, 5b, and 5n.

Subsequently, in a collaborative work system according to the present embodiment of the invention, some specific examples of the operation of granting/removing the manipulation authority over a certain manipulation area by the cursors of each user will be described.

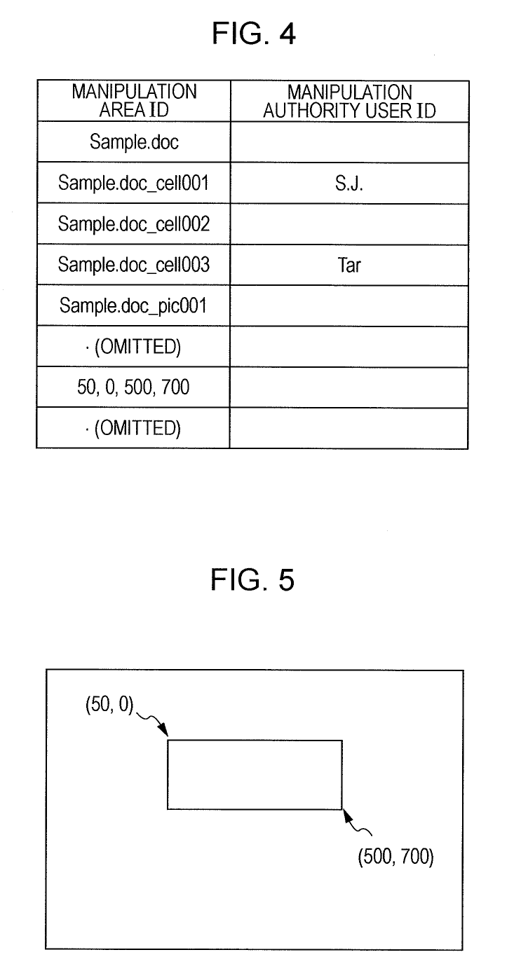

FIG. 4 illustrates an exemplary manipulation authority information table containing manipulation authority information recorded in the manipulation management unit 15 of the large scale display device 3 and the terminal devices 5a, 5b, and 5n.

Referring to FIG. 4, for each of one or more manipulation areas set, a manipulation area ID for identifying that manipulation area and a manipulation authority user ID for identifying a user with that manipulation authority are recorded in association with each other in this manipulation authority information table. For example, in the manipulation area corresponding to a manipulation area ID “Sample.doc_cell001” (e.g., a certain component (e.g., a paragraph) in a single file having a file name “Sample.doc”), the manipulation authority user ID “S. J” corresponding to a user with that manipulation authority is registered. In the manipulation area corresponding to the manipulation area ID “50, 0, 500, 700” (e.g., a rectangular area having “50, 0” and “500, 700” as coordinates of its start point and end point on the display screen, respectively), there is no user with the manipulation authority thereof at this moment.

As shown in FIG. 4, as a format of the manipulation area ID, a plurality of types of formats can be used as follows:
(1) (Window ID)_(Component ID), or (Window ID);
(2) (File Name)_(Component ID), or (File Name);
(3) (Start Point X-coordinates),(Start Point Y-coordinates),(End Point X-coordinates),(End Point Y-coordinates); and
(4) (Window ID),(Start Point X-coordinates),(Start Point Y-coordinates),(End Point X-coordinates),(End Point Y-coordinates).

The format (1) can be applied even when a window is displayed on the display screen and no file is displayed on that window. By using the formats (1) and (2), the manipulation authority can be controlled in units of a window, a file, and such a component. In addition, the “window ID” of a certain window refers to a “file ID” of the file displayed on that window, and vice versa. Furthermore, instead of the format (1), the format (2) may be used.

As shown in FIG. 5, the format (3) defines a manipulation area using the coordinates of the start and end points of that manipulation area on the display screen (e.g., a set of X-coordinate and Y-coordinate represented by the number of pixels from the origin on the display screen). In the example of FIG. 5, a rectangular manipulation area having X and Y coordinates of a start point (50, 0) and an end point thereof (500, 700) is illustrated. This format is less preferable than other formats from the viewpoint of an information processing amount or update frequency because it is necessary to update the coordinates whenever the manipulation area moves on the display screen. However, this format is convenient when an area where a window or file is not yet opened on the display screen is set as a manipulation area.

All the aforementioned formats (1) to (4) or at least one of them may be used. When the format (3) representing the coordinates is used in combination with other formats, it is preferable that the coordinate information of the corresponding manipulation area ID is obtained using an image drawing function of an UI(User Interface) of an OS of the collaborative work apparatus or the like based on the manipulation area ID of another format, and then the control is performed in such a way that the manipulation area having the format (3) and the manipulation area having another format does not conflict with each other.

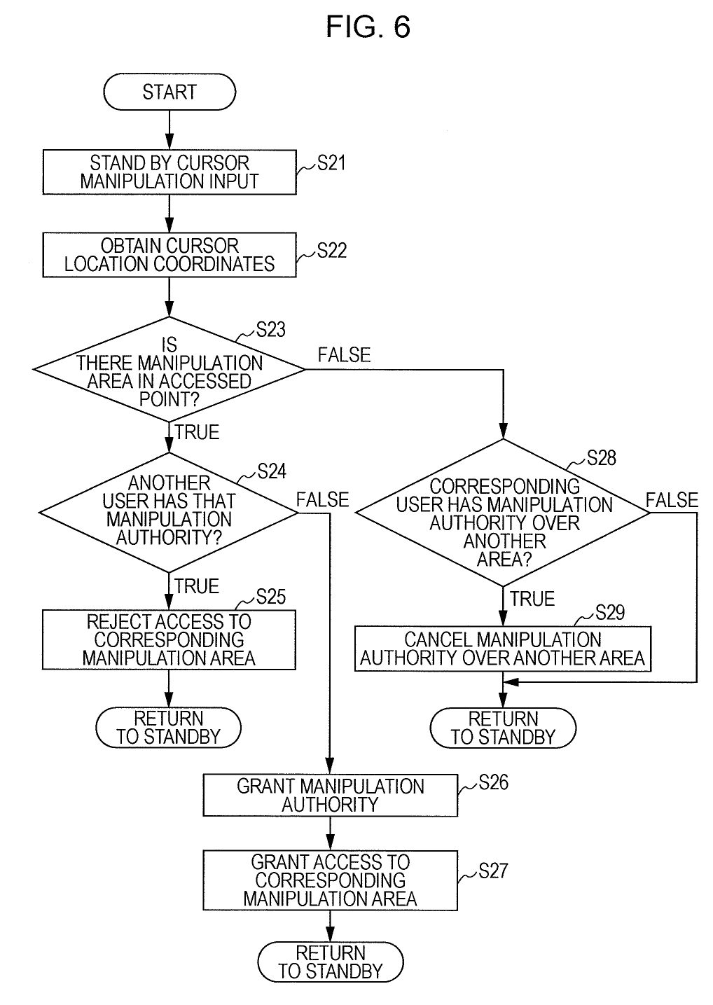

FIG. 6 is a flowchart illustrating an exemplary process flow of granting/removing the manipulation authority, executed by the cursor manipulation control unit 13 of the large scale display device 3.

Referring to FIG. 6, in step 521, the cursor manipulation input unit 11 of the large scale display device 3 is in a standby state for receiving the cursor manipulation signal from each terminal device. Then, when a cursor manipulation signal of a certain user is input from a certain terminal device, the cursor manipulation control unit 13 obtains the coordinates of the cursor of the corresponding user based on the received cursor manipulation signal (in step S22) and determines whether or not there is a manipulation area in the access point of that cursor (in the real-time setting, including an area that can be set as a manipulation area from now on as well as the manipulation area that has been already set) (in step S23).

In this case, if it is determined that there is a manipulation area in the access point of that cursor (TRUE in step S23) (i.e., that manipulation area is the requested manipulation area of the corresponding user), then it is determined whether or not the manipulation authority over that manipulation area is occupied by another user different from the corresponding user based on the manipulation authority information as illustrated in FIG. 4 (in step S24). If it is determined that the manipulation authority over that manipulation area is occupied by another user (TRUE in step S24), then the cursor of the corresponding user is rejected to access that manipulation area (in step S25). The control process is returned to step S21.

Otherwise, in step S24, if it is determined that the manipulation area (i.e., the requested manipulation area) where the corresponding user tries to access is not occupied by another user (FALSE in step S24), then the manipulation authority over that manipulation area is granted to the corresponding user (in step S26), and the cursor of the corresponding user is permitted to access the corresponding manipulation area (in step S27). Then, the control process is returned to step S21.

In step S23, if it is determined that there is no manipulation area in the access point of that cursor (FALSE in step S23) (in this case, that cursor may possibly get out of the manipulation area of which the manipulation authority is held by the corresponding user), then it is determined which manipulation authority over a manipulation area is held by the corresponding user (in step S28). If it is determined that there is such a manipulation area (TRUE in step S28), then the manipulation authority over that manipulation area is cancelled (i.e., removed from the corresponding user) (in step S29). Then, the control process is returned to step S21.

Otherwise, in step S28, if it is determined that there is no manipulation area of which the manipulation authority is held by the corresponding user (FALSE in step S28), then the control process is returned to step S21.

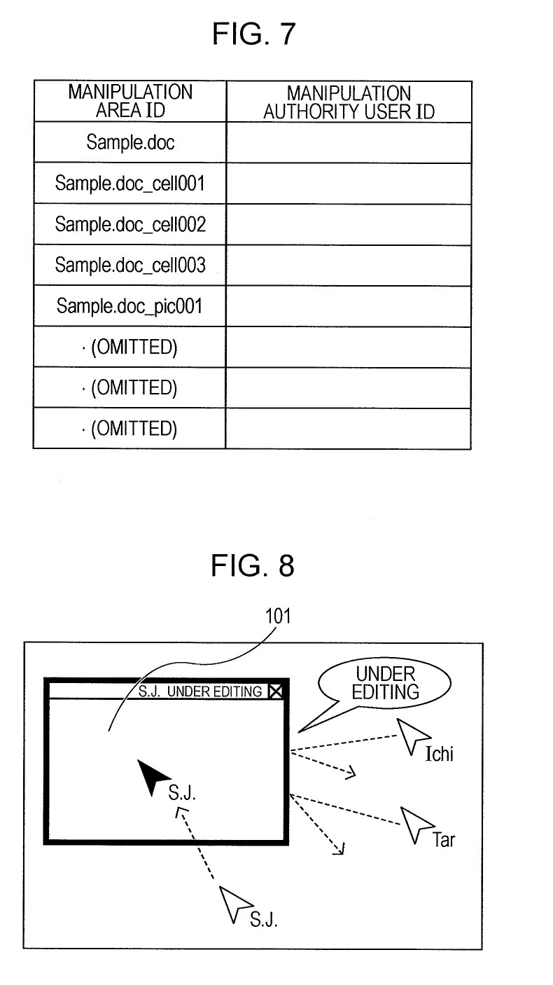

FIG. 7 illustrates an exemplary manipulation authority information table when none of the manipulation authoriy of the manipulation areas are granted to anybody. Referring to FIG. 7, the manipulation authority user ID is registered for none of the manipulation areas.

FIG. 8 illustrates a display screen when a user “S. J” obtains the manipulation authority over the entire window of a manipulation area ID “Sample.doc” in the state of FIG. 7.

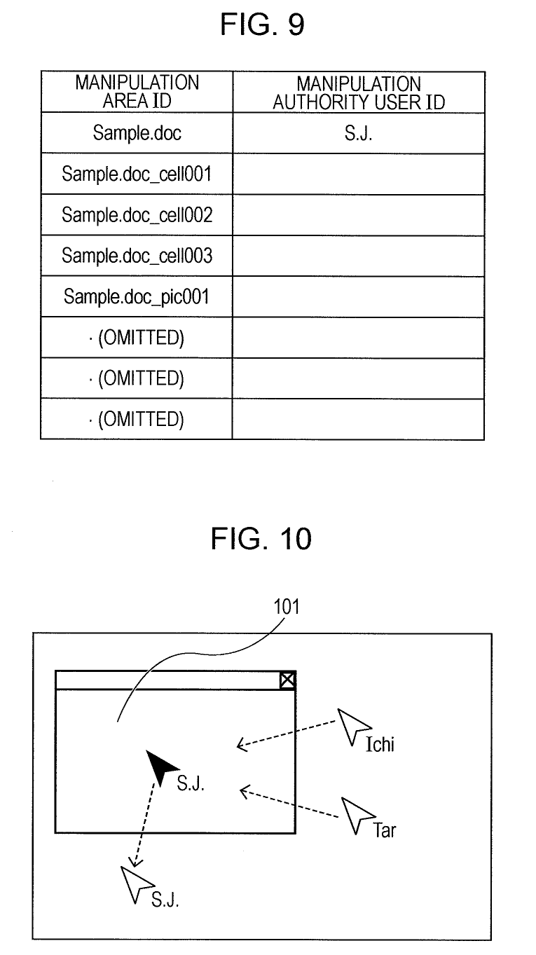

Referring to FIG. 8, when the cursor of the user “S. J” accesses the manipulation area of the window 101 of which the manipulation authority has not yet been granted to anybody, the manipulation authority over that window 101 is granted to the user “S. J”, and also, the cursor image of the user “S. J” is changed so that the window 101 is enclosed with a predetermined frame line. In the manipulation authority information as shown in FIG. 9, the manipulation authority user ID of the user “S. J” is registered in association with the manipulation area ID “Sample.doc” of the window 101.

The user “S. J” is allowed to edit a file or the like displayed on the window 101 by obtaining the manipulation authority over the window 101. Meanwhile, when other users “Ichi” and “Tar” try to access that window 101, a dialog, for example, “under editing” is displayed, and the cursors of other users “Ichi” and “Tar” are rejected to access the window 101. As a modified example, the cursors of other users “Ichi” and “Tar” may be allowed to access the window 101, but may be inhibited to edit a file within that window 101.

FIG. 10 illustrates an exemplary display screen when the user “S. J” loses the manipulation authority by moving the cursor out of the window 101 from the state of FIG. 8.

Referring to FIG. 10, when the cursor of the user “S. J” moves out of the window 101, the user “S. J” loses manipulation authority over the window 101. The manipulation authority information is updated as shown in FIG. 7. After losing manipulation authority over the window 101, the user “S. J” is not allowed to edit a file or the like displayed on the window 101 unless the user newly obtains manipulation authority over the window 101. When the cursor of another user “Ichi” or “Tar” accesses the window 101, another user “Ichi” or “Tar” can newly obtain the manipulation authority over the window 101. Needless to say, the user “S. J” can obtain manipulation authority over the window 101 again when the cursor of the user “S. J” accesses the window 101 again earlier than others.

As a modified example, while the user “S. J” puts its cursor onto the window 101 in the state of FIG. 8, the user “S. J” may also lose the manipulation authority over the window 101 when no manipulation is executed (e.g., by clicking a mouse, moving a cursor, or editing (during the editing, the cursor also moves accordingly)) for a predetermined time. In this case, the user “S. J” may obtain manipulation authority over the window 101 again when the user “S. J” makes any cursor manipulation such as mouse clicking on the window 101.

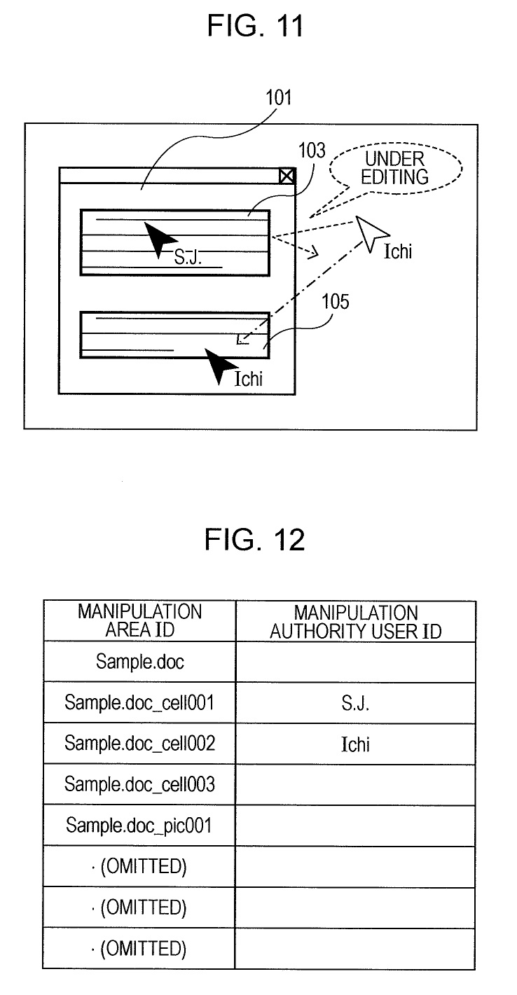

FIG. 11 illustrates an exemplary display screen when each of different users “S. J” and “Ichi” obtains manipulation authority over a different manipulation area within a certain window 101.

Referring to FIG. 11, when the cursor of the user “S. J” accesses the first manipulation area 103 within the window 101 (e.g., a first paragraph of a certain file opened in the window 101), the manipulation authority over the first manipulation area 103 is granted to the user “S. J”. Now, even when another user “Ichi” tries to access the first manipulation area 103, it is rejected. However, when the cursor of another user “Ichi” accesses a second manipulation area 105 (e.g., a second paragraph of the same file) different from the first manipulation area 103, the manipulation authority over the second manipulation area 105 is granted to another user “Ichi”. In the manipulation authority information, for example, as shown in FIG. 12, the manipulation authority user IDs of the “S. J” and “Ichi” are registered in association with the manipulation area IDs “Sample.doc_cell001” and “Sample.doc_cell002” of the first and second manipulation areas, respectively. Each of the users “S. J” and “Ichi” can edit different manipulation areas in the same file on the same window.

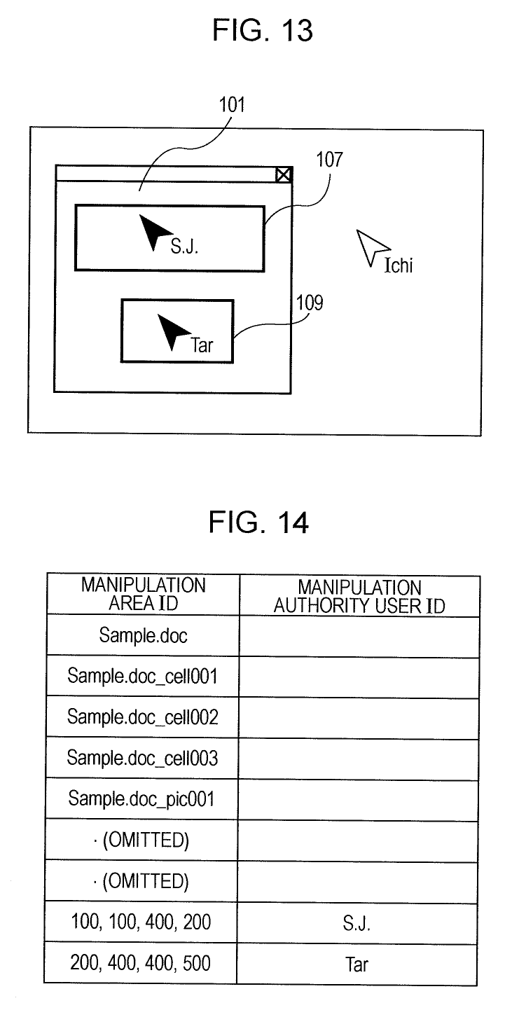

FIG. 13 illustrates an exemplary display screen when each of the users “S. J” and “Tar” has manipulation authority over a different manipulation area 107 and 109, respectively, within the same window 101. When the users “S. J” and “Tar” designate first and second rectangular ranges 107 and 109 within the window 101, respectively, that are not overlapped with each other, by using a method of designating ranges (e.g., by moving the cursor from the start point to the end point of the rectangular range while pressing the mouse button, and then, releasing the mouse button), the users “S. J” and “Tar” can obtain the manipulation authority over the first and second rectangular ranges 107 and 109, respectively, as shown in FIG. 13. In the manipulation authority information, as illustrated in FIG. 14, the manipulation authority user IDs of the users “S. J” and “Tar” are registered in association with the manipulation area IDs (100, 100, 400, 200) and (200, 400, 400, 500) of the first and second rectangular ranges 107 and 109, respectively.

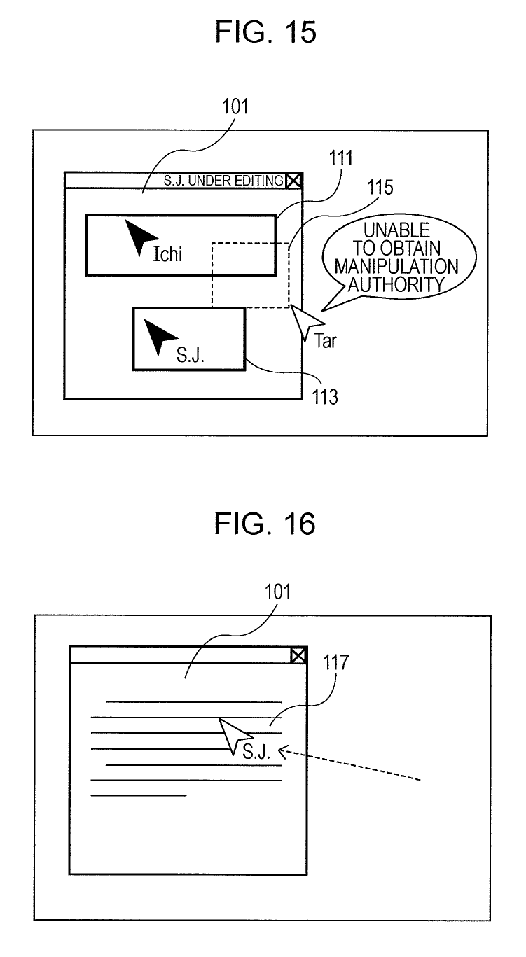

FIG. 15 illustrates an exemplary display screen when another user “Tar” designates a certain manipulation area in the state of FIG. 13. If the user “Tar” designates a third manipulation area 115 which conflicts with the first manipulation area 111 already occupied by a different user as shown in FIG. 15, the user “Tar” is rejected to obtain the manipulation authority over the third manipulation area 115.

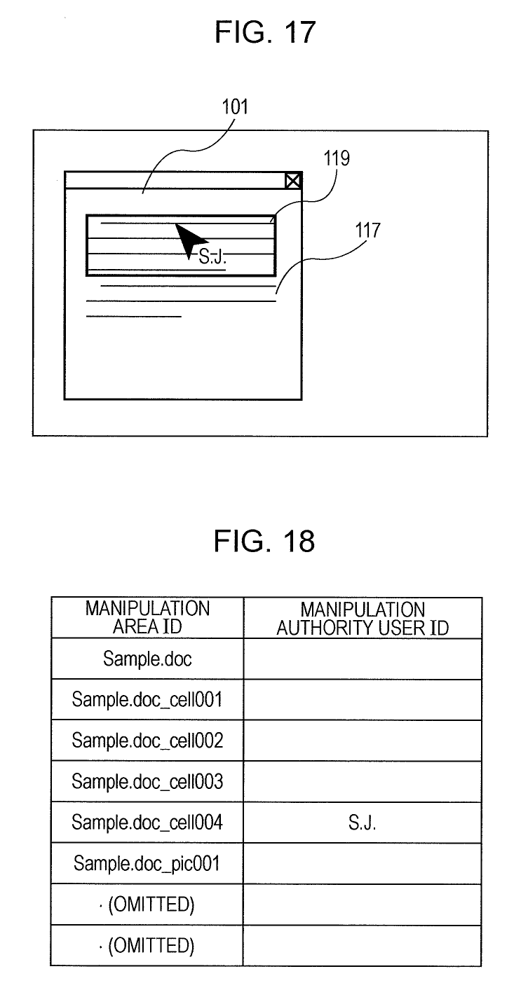

In the aforementioned specific example, the manipulation authority over a manipulation area is granted by allowing the cursor to access the manipulation area or designating the manipulation area. However, as a modified example, manipulation authority over the manipulation area may be granted when the user starts editing after the cursor accesses the manipulation area. FIG. 16 illustrates an exemplary display screen when the cursor of the user “S. J” accesses the window 101 in such a modified example. FIG. 17 illustrates an exemplary display screen when the user “S. J” starts editing on a certain file within the window 101 in succession to the state of FIG. 16.

Referring to FIG. 16, even when the cursor of the user “S. J” accesses an area 117 of a certain file within the window 101, the manipulation authority is not granted to the user “S. J” at this moment. Then, as shown in FIG. 17, when the user “S. J” puts the cursor into a certain place within the area 117 of that file and starts editing (such as inputting a character or inserting a figure), the manipulation area 119 including the place where the editing starts is detected (this place becomes the requested manipulation area of the user “S. J”), and the manipulation authority over that manipulation area 119 is granted to the user “S. J”. In the manipulation authority information, as shown in FIG. 18, the manipulation authority user ID of the user “S. J” is registered in association with the manipulation area ID “Sample.doc_cell004” of the manipulation area 119.

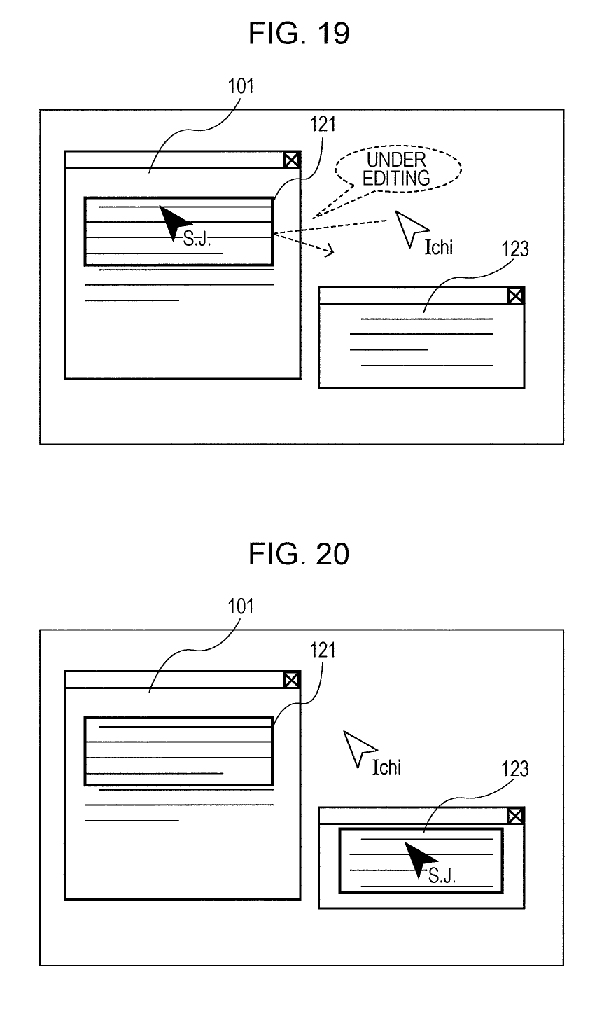

FIGS. 19 to 21 illustrate exemplary display screens when the user “S. J” loses manipulation authority over a certain manipulation area.

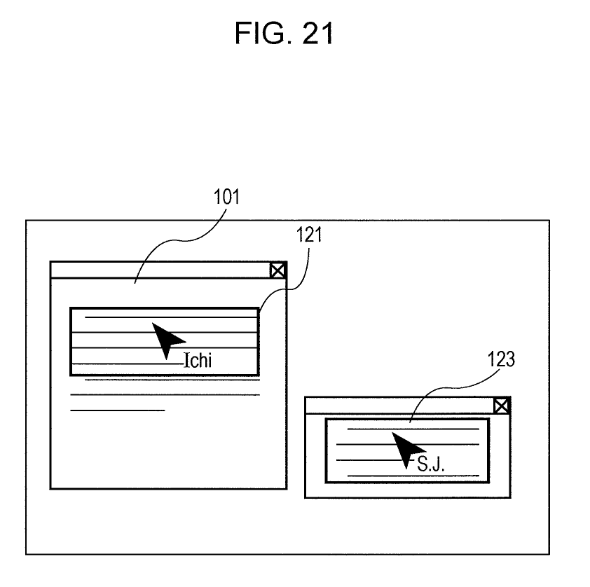

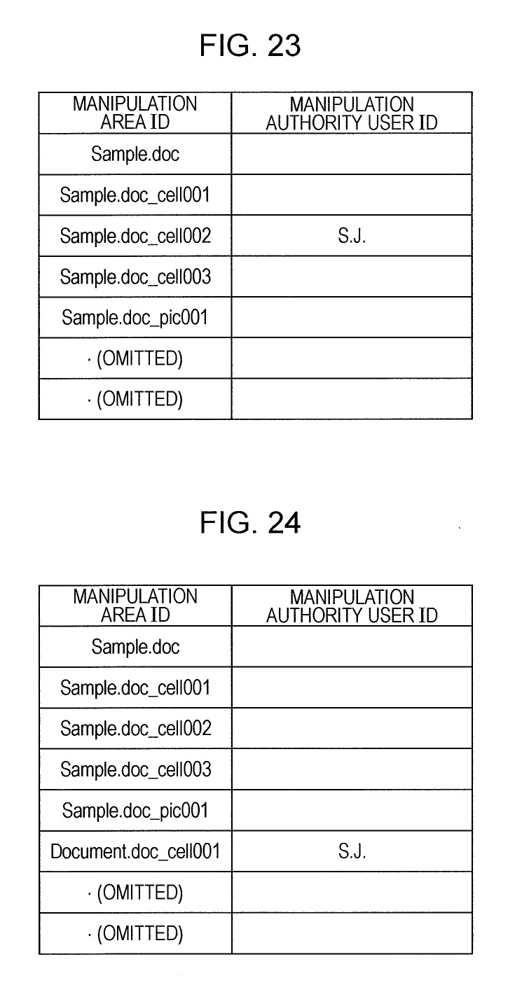

Referring to FIG. 19, it is supposed that the user “S. J” has manipulation authority over the manipulation area 121. Also, it is supposed that manipulation information is set as shown in FIG. 23 (the manipulation area ID of the manipulation area 121 is “Sample.doc_cell002”), then, as shown in FIG. 20, the cursor of the user “S. J” moves to another manipulation area 123, and the user “S. J” newly obtains the manipulation authority thereof. As a result, as shown in FIG. 21, the user “S. J” loses the manipulation authority over the former manipulation area 121. The manipulation authority information is updated as shown in FIG. 24 (the manipulation area ID of the manipulation area 123 is “Document.doc_cell001”). Then, as shown in FIG. 21, if the cursor of another user “Ichi” accesses the manipulation area 121, the user “Ichi” obtains the manipulation authority over the manipulation area 121. The users “S. J” and “Ichi” may execute editing in different manipulation areas on the same display screen.

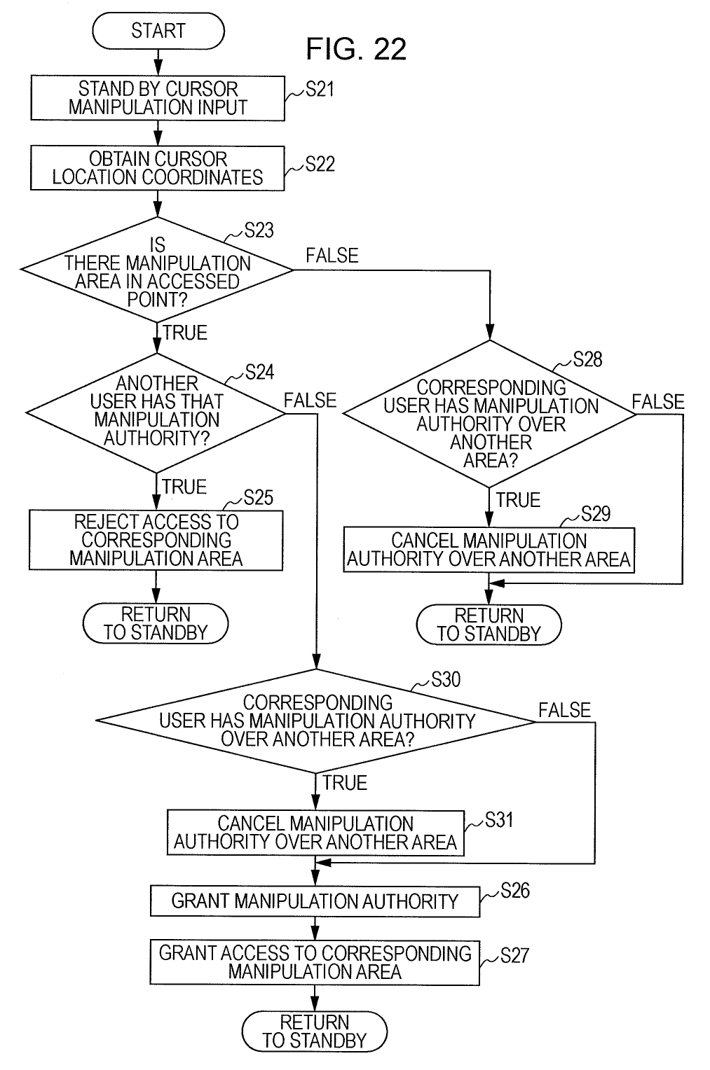

FIG. 22 is a flowchart for controlling grating/depriving the manipulation authority illustrated in FIGS. 19 to 21. The flowchart of FIG. 22 is obtained by adding steps S30 and S31 to the flowchart of FIG. 6. Therefore, only the added portion will be described, and other portions will not be repetitively described.

In step S24 of the flowchart shown in FIG. 22, if it is determined that the manipulation authority over the manipulation area where a cursor of a certain user tries to access is not held by other users (FALSE in step S24), then it is determined whether or not the corresponding user has manipulation authority over another manipulation area (in step S30). As a result of step S30, if it is determined that the corresponding user has manipulation authority over another manipulation area (TRUE in step S30), then the corresponding user is deprived of manipulation authority over the other manipulation area (in step S31). Even when either result is obtained in step S30, the manipulation authority over the manipulation area where the cursor of the corresponding user tries to access is granted to that user (in step S26), and the cursor is permitted to access that manipulation area (in step S27).

According to the present embodiment of the invention, freedom of a collaborative work by a plurality of users can be improved because each of users can obtain manipulation authority over a desired manipulation area without conflicting with one another and edit each manipulation area. Since cursors of other users are limited to access the manipulation area held by a certain user, it is possible to harmoniously execute the collaborative work by a plurality of users without hindering between users. The manipulation authority is newly granted to each user when a condition, with which it is generally thought with a high possibility that the user desires to have the manipulation authority of the manipulation area, is satisfied (e.g., when a cursor enters that manipulation area, when that manipulation area is designated using a cursor, or when a user starts editing on that manipulation area). Similarly, the existing manipulation authority is removed from each user when a condition, with which it is generally thought with a high possibility that the user does not need the existing manipulation authority any more or that another user desired to have the manipulation authority, is satisfied (e.g., when there is no cursor manipulation from each user for a predetermined time, when the cursor moves out of that manipulation area, or when the user newly obtains manipulation authority over another manipulation area). As a result, transition of the manipulation authority between users can be easily executed, and the collaborative work can be harmoniously executed.

In addition, when a plurality of users simultaneously execute editing in different manipulation areas, it is necessary to change display locations for each manipulation area on the display screen according to the progress of the editing. Such change of display locations may be executed according to technologies known in the art.

While embodiments of the invention have been described, the description is just exemplary of the invention, and is not intended to limit the scope of the invention. Without departing from the subject matter thereof, the invention may be embodied in various forms.

The entire disclosure of Japanese Patent Application No. 2009-023051, filed Feb. 3, 2009 is expressly incorporated by reference herein.

What is claimed is:

1. A collaborative work apparatus comprising:
a display unit that simultaneously displays work contents edited or referenced by a plurality of users and cursors of a plurality of the users on a display screen;
a cursor manipulation input unit that inputs a cursor manipulation signal for each cursor;
a cursor manipulation control unit that sets one or more manipulation areas on the display screen and executes control of cursor locations for each of the users on the display screen and control of granting/removing manipulation authority over each manipulation area to/from any one of the users in response to the cursor manipulation signal input from the user through the cursor manipulation input unit; and
manipulation authority management unit that manages manipulation authority information representing which user has the manipulation authority over which manipulation area in response to the control of granting/removing the manipulation authority by the cursor manipulation control unit;
wherein the cursor manipulation control unit includes
a manipulation area detection unit that detects which manipulation area is requested by each of the users on the display screen based on the cursor manipulation signal from each of the users,
a manipulation authority determination unit that determines which user has the manipulation authority over the requested manipulation area detected by the manipulation area detection unit based on the manipulation authority information,
a manipulation authority grant unit that determines whether or not the manipulation authority over the requested manipulation area is granted to the requesting user according to a result of determination by the manipulation authority determination unit, and
a manipulation authority deprivation unit that determines whether or not each of the users satisfies a predetermined manipulation authority disqualifying condition and whether or not the manipulation authority held by each of the users is deprived based on the cursor manipulation signal from each user.

2. The collaborative work apparatus according to claim 1, wherein the cursor manipulation control unit further includes:
a cursor access control unit that controls whether or not the cursor of each of the users is permitted to access each manipulation area based on the manipulation authority information.

3. The collaborative work apparatus according to claim 1, wherein the manipulation authority grant unit grants manipulation authority over the requested manipulation area to the requesting user when none of the users have the manipulation authority over the requested manipulation area but does not grants the manipulation authority over the requested manipulation area to the requesting user when another user has the manipulation authority over the requested manipulation area.

4. The collaborative work apparatus according to claim 1, wherein, when a cursor of a certain user tries to access a certain manipulation area, if the manipulation authority over the corresponding manipulation area is not held by another user, the cursor manipulation control unit permits the cursor of the corresponding user to access the corresponding manipulation area, whereas if the manipulation authority over the corresponding manipulation area is held by another user, the cursor manipulation control unit inhibits the cursor of the corresponding user to access the corresponding manipulation area.

5. The collaborative work apparatus according to claim 1, wherein, when a cursor of a certain user tries to access a certain manipulation area, the manipulation area detection unit detects the corresponding manipulation area as a requested manipulation area of the corresponding user.

6. The collaborative work apparatus according to claim 1, wherein, when a cursor of a certain user designates a certain manipulation area, the manipulation area detection unit detects the corresponding area as a requested manipulation area of the corresponding user.

7. The collaborative work apparatus according to claim 1, wherein, when a cursor of a certain user starts editing in a certain place on the work contents, the manipulation area detection unit detects a manipulation area including the corresponding place as a requested manipulation area of the corresponding user.

8. The collaborative work apparatus according to claim 1, wherein, when cursor manipulation of a user with manipulation authority over a certain manipulation area has not been executed for a predetermined time, the manipulation authority deprivation unit deprives the manipulation authority over the corresponding manipulation area held by the corresponding user.

9. The collaborative work apparatus according to claim 1, wherein, when a cursor of a user with manipulation authority over a certain manipulation area moves out of the corresponding manipulation area, the manipulation area deprivation unit deprives the manipulation authority over the corresponding manipulation area held by the corresponding user.

10. The collaborative work apparatus according to claim 1, wherein, when a cursor of a user with manipulation authority over a first manipulation area newly obtains manipulation authority over a second manipulation area, the manipulation authority deprivation unit deprives the manipulation authority over the first manipulation area held by the corresponding user.

11. The collaborative work apparatus according to claim 1, further including a cursor display control unit that controls a display state of each cursor to visually distinguish a cursor of a user who has or obtains manipulation authority over any manipulation area from a cursor of a user who does not.

12. The collaborative work apparatus according to claim 1, further including an area display control unit that controls a display state of each manipulation area to visually distinguish a manipulation area of which manipulation authority is held by any user from a manipulation area of which manipulation authority is held by none of users.

13. The collaborative work apparatus according to claim 1, wherein the collaborative work apparatus is communicatably connected to one or more other terminal devices via a communication network, and
wherein the cursor manipulation input unit inputs a cursor manipulation signal input to collaborative work apparatus from a host user and a cursor manipulation signal input to one or more other terminal devices from one or more other users.

14. A method of controlling a collaborative work, the method comprising the steps of:
simultaneously displaying work contents edited or referenced by a plurality of users and cursors of a plurality of the users on a display screen;
inputting a cursor manipulation signal for each cursor;
setting one or more manipulation areas on the display screen;
executing control of a cursor location of each of the users on the display screen and control of granting/removing manipulation authority over each manipulation area to/from each of the users in response to the cursor manipulation signal of each of the users, input through the inputting the cursor manipulation signal; and
managing manipulation authority information representing which user has manipulation authority over which manipulation area in response to the control of granting/removing the manipulation authority obtained through the executing control,
wherein the executing control includes
detecting which manipulation area is requested by each of the users on the display screen based on the cursor manipulation signal of each of the users,
determining which user has the manipulation authority over the requested manipulation area of each of the users, detected through the detecting which manipulation area is requested based on the manipulation authority information,
determining whether or not the manipulation authority over the requested manipulation area is granted to each of the users according to a result of the determination obtained through the determining which user has the manipulation authority, and
determining whether or not each of the users satisfies a predetermined manipulation authority disqualifying condition and whether or not the manipulation authority held by each of the users is deprived based on the cursor manipulation signal of each user.
